(19) United States
(12) Patent Application Publication
(10) Pub. No.: US 2001/0044740 A1
(43) Pub. Date: Nov. 22, 2001

(54) Real time contribution margin

(76) Inventor: Roger P. Hoffman, Green Bay, WI (US)

Correspondence Address: Philip M. Weiss, Weiss & Weiss PC, 500 Old Country Road, Suite 305, Garden City, NY, 11530, US

(21) Appl. No.: 09/860,715

(22) Filed: May 18, 2001

Related U.S. Application Data
(60) Provisional application No. 60/205,809, filed on May 19, 2000.

(51) Int. Cl. G06F 17/60

(52) U.S. Cl. 705/10; 705/26; 705/35

(57) ABSTRACT

The present invention relates to a system and method for reviewing business decisions in real time.

### FIELD OF THE INVENTION

The present invention relates to a system and method for reviewing business decisions in real time.

### BACKGROUND OF THE INVENTION

Today's manufacturers are not making business decisions or reviewing operational performance on a real or near real time performance. Instead, they are relying on financial, production and other reports which reflect averages for the particular period of time covered in the report. Contribution Margin is one type of financial performance. It can be defined as sales price, net of selling costs and transportation, less the actual cost of manufacturing, which are typically referred to as variable costs. Variable costs are all costs which are not fixed costs. Fixed costs are items such as overhead, which do not vary depending on levels of production.

In most corporate structures, it is necessary to break out work groups into different functionality. For example, Production, Procurement, Marketing, Sales, Accounting, Human Resources, are all separate functions-albeit linked through enterprise resources planning systems in modem environments.

The major emphasis recently is through the vehicle of Enterprise Resources Planning (ERP), to improve a supply chain management so as to reduce the amount of work in process and inventory in the system. The goal of this type of system, embodied in U.S. Pat. No. 6,049,742 is to ensure rapid response and concurrently minimize the amount of capital tied up in processing orders.

U.S. Pat. No. 6,049,742 relates to a projected supply planning matching assets with demand in microelectronics manufacturing. A computer-implemented decision support tool serves as a solver to generate a projected supply planning (PSP) or estimated supply planning (ESP) match between existing assets and demands across multiple manufacturing facilities within the boundaries established by the manufacturing specifications and process flows and business policies to determine what supply can be provided over what time frame by manufacturing and establishes a set of actions or guidelines for manufacturing to incorporate into their manufacturing execution system to ensure that the delivery commitments are met in a timely fashion.

U.S. Pat. No. 5,937,064 relates to a system and method for interactive visualization, analysis and control of a dynamic database. Real time data summaries from a common database are produced within a network. A line document program is stored within the network enabling selective visual analysis and displays of the data when the data summaries are downloaded at computer terminals at a plurality of sites.

### SUMMARY OF THE INVENTION

The present invention relates to a system for providing contribution margin/profit or other performance information for a business decision that could be made or has been made. It is an object of the present invention to instantly provide performance feedback, such as contribution margin earned, for a purchase or sales transaction that has occurred. It is especially relevant for Internet transaction engines.

The present invention can build upon prior Enterprise Planning Solution methodology, but can also operate independently.

The present invention relates to the inter-relationship that exists between units that are purchased and units that are sold from a currency perspective, to ensure that the purchases and sales match up in such a fashion that the manufacturing facility is generating a continuous profit margin.

### DETAILED DESCRIPTION OF THE INVENTION

All manufacturing operations have a series of curves that represent the amount of units consumed as a function of throughput. Examples being in: labor, week days may have no overtime associated with them, but weekends may be at time and one half or double time rates; Power; electrical costs can vary as much as 100 fold based on time of usage. During periods of shortage, such as hot summer months, power costs can surge. Raw material costs can vary greatly depending upon whether the pricing was spot pricing or contract pricing, and depending upon the transportation costs.

For example, if a product were sold on the Internet, the financial performance of the transaction would be immediately reported to the appropriate party via the Internet. The party, in this example, could be the sales agent, the sales manager, or other management personnel. To be relevant and accurate on a real time or near real time basis, the revenue from the sales transaction would be compared against the current cost of the transaction. Such current cost could include real time or near real time purchase transactions and facility raw material consumption data that would be available in electronic format from the facility computer systems or company-wide transaction computers.

For example, a transaction to sell a ton of paper is occurring on the Internet. Instantly after the transaction occurs, the present invention computing device gathers information and performs computations relating to the financial performance of the transaction. The computing device gathers logistic information regarding the proposed shipment of the paper and calculates the logistics, i.e., cost of shipping the paper to the customer. In one embodiment, the computing device gathers data from where the paper was produced or will be produced relating to how much consumables and other manufacturing requirements, such as wood fiber, chemicals, steam, electricity and labor, went into manufacturing the ton of paper (or is currently going into manufacturing a ton of that particular type of paper). The computing device then gathers data relating to the current purchase price of consumables for computing the real time financial performance of the transaction. Current transaction cost or forecasted cost for wood purchases at the designated manufacturing facility where the paper is or will be produced is ascertained. In one embodiment the forecasted cost is obtained from a third party authority that specializes in forecasting which makes such information available via the Internet. Such cost would be multiplied by the consumption data for each particular consumable that is used in the manufacturing of the product to compute a total real time cost of the product. This cost of manufacturing together with the logistic cost of shipping the product is summed together for a total delivered real-time cost. Such real time cost computed by the present invention could be compared to the transaction price and instantly provide performance feedback for the transaction conducted. Similarly, a user could provide a proposed transaction and instantly receive feedback with the system of the present invention on what financial performance would occur if such transaction would take place.

Similarly, consumable purchase and proposed purchase transactions can likewise receive such information from the system of the present invention. For example, a raw material procurement decision can receive immediate profit or margin contribution feedback based on current selling prices of products to be manufactured from the particular raw material, current prices of other needed raw materials for the product and the facility's required cost to manufacture based on consumption of the raw materials.

In one embodiment, the system of the present invention indicates on a real or near real time basis whether a facility would need to curtail or even completely stop production, based on certain data which shows that manufacturing is unprofitable. For example, should a particular raw material such as energy, which can fluctuate within discrete periods (even within a matter of hours), escalate in price to a level that makes manufacturing unprofitable or generate negative contribution margin, the manufacturing facility can curtail or stop production during that period.

While the system of the present invention can reside at the facility or company, it also could reside at a third party site. For example, a program, including Java based technology, could receive Internet transmission of data from a subscribing company which uses the program as a check system to monitor performance of transactions. Such transactions may or may not be occurring on the Internet. For example, company x may have a sale or purchase transaction enter their own computer accounting system. The computer system could relay information over the Internet to a third party program which receives the data, performs the calculations as discussed above, and provides financial performance feedback via the Internet or in other methods back to the company. The accuracy of the computed performance feedback in this third-party scenario would depend on the level of detailed information provided by the company. Industry averages and other industry studies can be used in place of detailed information provided by the company. While not as accurate as actual data from the company, the accuracy is generally not as critical. It is not critical because financial statements provide the accurate performance measures. An important benefit of the system of the present invention is to provide reasonable guidelines and awareness in real time for transactions and proposed transactions. Additional accuracy, while helpful, is not critical. The application of the system of the present invention could go into a wide range of commerce activities, particularly manufacturing operations.

A company using the system of the present invention could establish preset limits that would apply for all purchases or sales such that in no event would a purchase or sale be made without a level of profit or contribution attached to it.

What is claimed is:

1. A system for providing contribution margin/profit or other performance information for a business decision that could be made or has been made comprising;
said system gathers information regarding a transaction;
performs computations relating to financial performance of said transaction;
gathers logistic information regarding proposed shipment of a good and calculates said cost of shipment;
gathers data from where a good was produced or will be produced relating to cost of consumables and other manufacturing requirements,
gathers data relating to current purchase price of consumables for computing real time financial performance of said transaction; and
multiplies said cost by said consumption data for each particular consumable that is used in manufacturing of said good to compute a total real time cost of said good.

2. The system of claim 1 wherein said system instantly provides performance feedback, such as contribution margin earned, for a purchase or sales transaction that has occurred.

3. A process for providing contribution margin/profit or other performance information for a business decision that could be made or has been made comprising;
selling a product on the Internet;
reporting financial performance of said sales transaction to an appropriate party via the Internet.
comparing revenue from said sales transaction against current cost of said transaction.

4. The process of claim 3 wherein said party is a sales agent, sales manager, or other management personnel.

5. The process of claim 3 wherein current cost includes real time or near real time purchase transaction and facility raw material consumption data.

6. The process of claim 5 wherein said data is available in electronic format from facility computer systems or company-wide transaction computers.

7. A process for providing contribution margin/profit or other performance information for a business decision that could be made or has been made comprising;
gathering information regarding a transaction;
performing computations relating to financial performance of said transaction;
gathering logistic information regarding proposed shipment of a good and calculating said cost of shipment.

8. The process of claim 7 further comprising;
gathering data from where a good was produced or will be produced relating to cost of consumables and other manufacturing requirements,
gathering data relating to current purchase price of consumables for computing real time financial performance of said transaction;
multiplying said cost by said consumption data for each particular consumable that is used in manufacturing of said good to compute a total real time cost of said good.

9. The process of claim 8 further comprising;
adding together cost of manufacturing with logistic cost of shipping said good for a total delivered real-time cost.

10. The process of claim 9 further comprising;
comparing said real time cost to transaction price to provide performance feedback for said transaction.

11. The process of claim 10 wherein said transaction is a proposed transaction.
